(19) United States
(12) Patent Application Publication
(10) Pub. No.: US 2025/0021307 A1
(43) Pub. Date: Jan. 16, 2025

(54) Device and Method of Handling a Modular Multiplication

(71) Applicant: PUFsecurity Corporation, Hsinchu County (TW)

(72) Inventor: Wen-Ching Lin, Hsinchu County (TW)

(73) Assignee: PUFsecurity Corporation, Hsinchu County (TW)

(21) Appl. No.: 18/896,829

(22) Filed: Sep. 25, 2024

Related U.S. Application Data
(62) Division of application No. 17/389,362, filed on Jul. 30, 2021.
(60) Provisional application No. 63/094,355, filed on Oct. 21, 2020.

(51) Int. Cl. G06F 7/72; G06F 5/01; G06F 7/505; G06F 7/523; G06F 7/535

(52) U.S. Cl. CPC G06F 7/722; G06F 5/01; G06F 7/505; G06F 7/523; G06F 7/535

(57) ABSTRACT

A modular operation device for handling a modular multiplication, comprises a controller, configured to divide a multiplicand into a plurality of multiplicand words, a multiplier into a plurality of multiplier words, and a modulus into a plurality of modulus words; a first plurality of processing elements, coupled to the controller, configured to compute a first plurality of updated carry results and a first plurality of updated sum results; a second plurality of processing elements, coupled to the controller, configured to compute a second plurality of updated carry results and a second plurality of updated sum results; and a reduction element, coupled to the controller, configured to compute a resulting remainder according to the second plurality of updated carry results and the second plurality of updated sum results.

### CROSS REFERENCE TO RELATED APPLICATIONS

This application is a division of U.S. Application No. 17/389,362, filed on Jul. 30, 2021, which claims the benefit of U.S. Provisional Application No. 63/094,355, filed on Oct. 21, 2020. The contents of these applications are incorporated herein by reference.

### BACKGROUND OF THE INVENTION

### 1. Field of the Invention

The present invention relates to a computing device, and more particularly, to a modular operation device and a method of handling a modular multiplication.

### 2. Description of the Prior Art

Modular multiplications of large operands are widely used in public-key cryptosystems. For example, operations of a modular multiplication may comprise computing carry results and sum results iteratively, and a resulting remainder may be computed according to the sum results. However, computations of a carry result and a sum result corresponding to a word depend on other carry results and other sum results corresponding to other words. The modular multiplication is implemented inefficiently. Thus, an efficient modular multiplication is an important problem to be solved.

### SUMMARY OF THE INVENTION

The present invention therefore provides a device and a method of handling a modular multiplication to solve the abovementioned problem.

A modular operation device for handling a modular multiplication comprises a controller, configured to divide a multiplicand into a plurality of multiplicand words, a multiplier into a plurality of multiplier words, and a modulus into a plurality of modulus words; a first plurality of processing elements, coupled to the controller, configured to compute a first plurality of updated carry results and a first plurality of updated sum results according to the plurality of multiplicand words, a multiplier word of the plurality of multiplier words, a first plurality of carry results and a first plurality of sum results, wherein at least two of the first plurality of processing elements compute at least two of the first plurality of updated carry results in parallel according to the multiplier word and at least two multiplicand words of the plurality of multiplicand words, and compute at least two of the first plurality of updated sum results in parallel according to the multiplier word and the at least two multiplicand words; a second plurality of processing elements, coupled to the controller, configured to compute a second plurality of updated carry results and a second plurality of updated sum results according to the plurality of modulus words, the first plurality of updated carry results and the first plurality of updated sum results; and a reduction element, coupled to the controller, configured to compute a resulting remainder according to the second plurality of updated carry results and the second plurality of updated sum results.

A modular operation device for handling modular multiplication comprises a controller, configured to divide a multiplicand into a plurality of multiplicand blocks, a multiplier into a plurality of multiplier blocks, and a modulus into a plurality of modulus blocks; a processing element, coupled to the controller, configured to execute instructions of: computing a first plurality of sum results according to a first multiplicand block of the plurality of multiplicand blocks, a first multiplier block of the plurality of multiplier blocks and a first modulus block of the plurality of modulus blocks; computing a second plurality of sum results and a plurality of delayed sum results according to a second multiplicand block of the plurality of multiplicand blocks, the first multiplier block and a second modulus block of the plurality of modulus blocks; computing a first plurality of updated sum results according to the first plurality of sum results, the plurality of delayed sum results, the first multiplicand block, a second multiplier block of the plurality of multiplier blocks and the first modulus block; computing a second plurality of updated sum results and a plurality of updated delayed sum results according to the second plurality of sum results, the second multiplicand block, the second multiplier block and the second modulus block; and a reduction element, coupled to the controller and the processing element, configured to compute a resulting remainder according to the first plurality of updated sum results, the second plurality of updated sum results and the plurality of updated delayed sum results.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a modular operation device according to an example of the present invention.

FIG. 2 is a schematic diagram of operations of a modular operation device according to an example of the present invention.

FIG. 3 is a table of parallel processing of processing elements according to an example of the present invention.

FIG. 4 are schematic diagrams of data flows of parallel processing of processing elements according to an example of the present invention.

FIG. 5 are schematic diagrams of processing elements according to an example of the present invention.

FIG. 6 is a schematic diagram of data dependency of carry results and sum results according to an example of the present invention.

FIG. 7 is a schedule table of operations of a modular multiplication according to an example of the present invention.

FIG. 8 is a flowchart of a process according to an example of the present invention.

FIG. 9 is a schematic diagram of operations of a modular operation device according to an example of the present invention.

FIG. 10 is a schematic diagram of operations of a modular operation device according to an example of the present invention.

FIG. 11 is a schedule table of operations of a modular multiplication according to an example of the present invention.

FIG. 12 is a schematic diagram of data dependency of carry results and sum results according to an example of the present invention.

FIG. 13 is a schematic diagram of data dependency of carry results and sum results according to an example of the present invention.

FIG. 14 is a schematic diagram of data dependency of carry results and sum results according to an example of the present invention.

FIG. 15 is a flowchart of a process according to an example of the present invention.

FIG. 16 is a flowchart of a process according to an example of the present invention.

FIG. 17 is a flowchart of a process according to an example of the present invention.

FIG. 18 is a schematic diagram of data flows of a processing element according to an example of the present invention.

### DETAILED DESCRIPTION

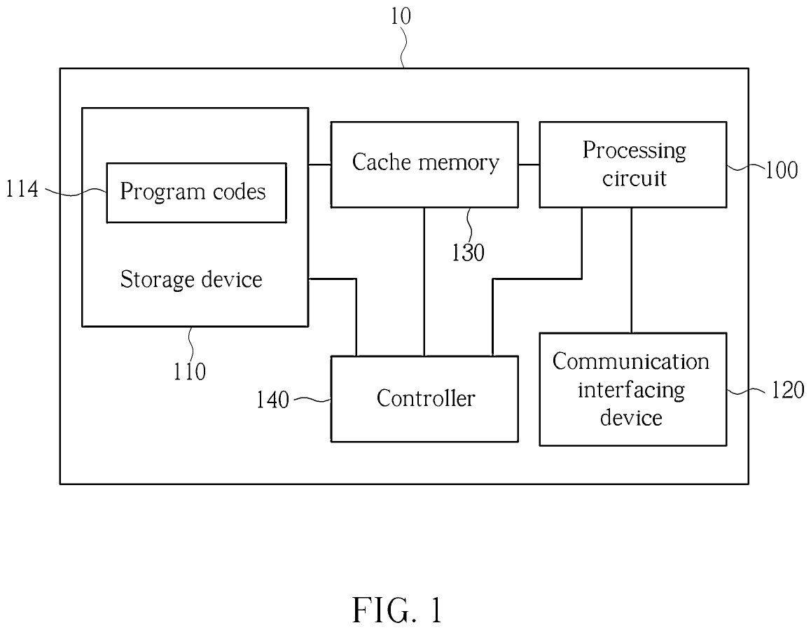

FIG. 1 is a schematic diagram of a modular operation device 10 according to an example of the present invention. The modular operation device 10 may include at least one processing circuit (e.g., unit or element) 100, at least one storage device 110, at least one communication interfacing device 120, at least one cache memory 130 and at least one controller 140. The at least one processing circuit 100 may be a (micro)processor, multi-core processor, Application Specific Integrated Circuit (ASIC) or Central Processing Unit (CPU).

The at least one storage device 110 may be any data storage device that may store program codes 114 which are accessed and executed by the at least one processing circuit 100. Examples of the at least one storage device 110 include but are not limited to a subscriber identity module (SIM), read-only memory (ROM), flash memory, random-access memory (RAM), Compact Disc Read-Only Memory (CD-ROM), digital versatile disc-ROM (DVD-ROM), Blu-ray Disc-ROM (BD-ROM), magnetic tape, hard disk, optical data storage device, non-volatile storage device, non-transitory computer-readable medium (e.g., tangible media), etc. The at least one communication interfacing device 120 is preferably at least one transceiver and is used to transmit and receive signals (e.g., data, messages and/or packets) according to processing results of the at least one processing circuit 100. The at least one cache memory 130 may be any type of cache memory (L1/L2/L3/L4/L5/L #). The at least one cache memory 130 may be accessed and executed by the at least one processing circuit 100, and may be connected directly with, in close proximity to or integrated as part of the at least one processing circuit 100. The at least one controller 140 may control the components included in the modular operation device 10.

According to a modular multiplication, operations of implementing the modular multiplication comprise computing carry results and sum results iteratively, and a resulting remainder may be computed according to the sum results. For example, a carry result Cⱼ₋₁ corresponding to a less significant word (e.g., 32 bits or 64 bits), a carry result Cⱼ and a sum result Sⱼ corresponding to a word, and a sum result Sⱼ₊₁ corresponding to a more significant word are computed iteratively. However, the sum result Sⱼ is computed based on the carry result Cⱼ₋₁. In addition, the sum result Sⱼ in a i-th iteration is computed based on the sum result Sⱼ₊₁ in a (i−1)-th iteration. The modular multiplication may be a Montgomery multiplication, but is not limited herein.

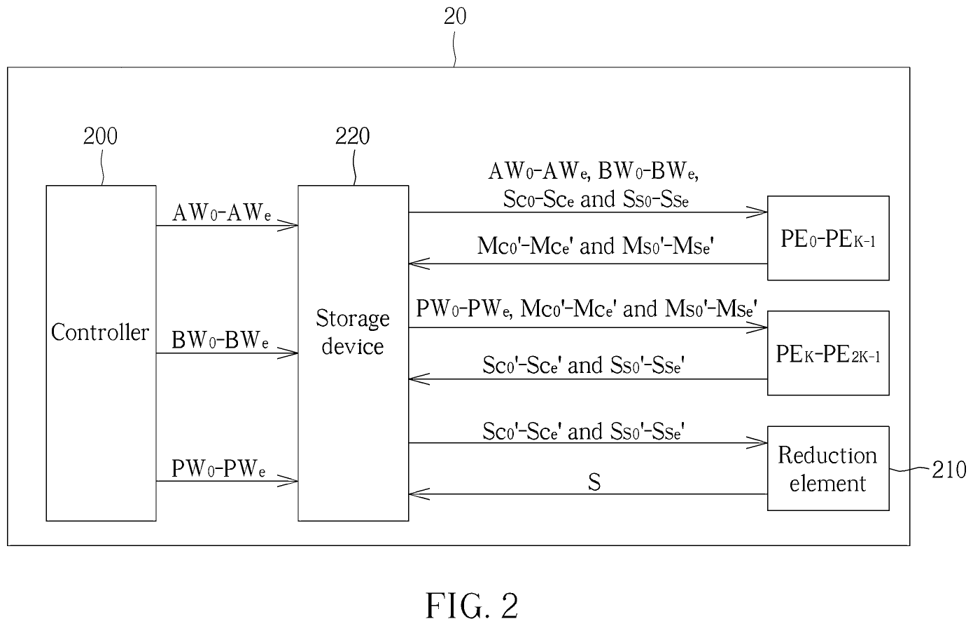

FIG. 2 is a schematic diagram of operations of a modular operation device 20 according to an example of the present invention. In FIG. 2, the modular operation device 20 comprises K processing elements PE₀-PE_{K-1}, K processing elements PE_{K}-PE_{2K-1}, a controller 200, a reduction element 210 and at least one storage device (e.g., main memory) 220, wherein K≥2. The controller 200 is coupled to the processing elements PE₀-PE_{K-1}, the processing elements PE_{K}-PE_{2K-1}, the reduction element 210 and the at least one storage device 220.

In detail, the modular operation device 20 is (used) for computing a modular multiplication (i.e., remainder) of a multiplicand A and a multiplier B with respect to a modulus P based on a Montgomery multiplication algorithm. The controller 200 is configured to divide the multiplicand A into (e+1) multiplicand words AW₀-AWₑ, the multiplier B into (e+1) multiplier words BW₀-BWₑ, and the modulus P into (e+1) modulus words PW₀-PWₑ, wherein e≥1. The processing elements PE₀-PE_{K-1} are configured to compute (e+1) updated carry results Mc₀′-Mcₑ′ and (e+1) updated sum results Ms₀′-Msₑ′ according to the multiplicand words AW₀-AWₑ, a multiplier word BWᵢ of the (e+1) multiplier words BW₀-BWₑ, (e+1) carry results Sc₀-Scₑ and (e+1) sum results Ss₀-Ssₑ (e.g., respectively). The processing elements PE_{K}-PE_{2K-1} are configured to compute (e+1) updated carry results Sc₀′-Scₑ′ and (e+1) updated sum results Ss₀′-Ssₑ′ according to the modulus words PW₀-PWₑ, the updated carry results Mc₀′-Mcₑ′ and the updated sum results Ms₀′-Msₑ′ (e.g., respectively). Then, the reduction element 210 is configured to compute a resulting remainder S according to the updated carry results Sc₀′-Scₑ′ and the updated sum results Ss₀′-Ssₑ′. That is, a two-step method is used for computing carry results and sum results. Thus, the problem regarding computing of iterative carry results and sum results is solved.

In one example, the processing elements PE₀-PE_{K-1} and the processing elements PE_{K}-PE_{2K-1} are the same.

In one example, the multiplicand A is an n-bit integer. In one example, each of the multiplicand words AW₀-AWₑ is a w-bit integer. In one example, a word number (e+1) of the (e+1) multiplicand words AW₀-AWₑ is obtained according to the w. For example, e=┌n/w┐, wherein ┌⋅┐ is a ceiling function. Note that word numbers and bit lengths of the (e+1) multiplicand words AW₀₉-AWₑ, the (e+1) multiplier words BW₀-BWₑ and the (e+1) modulus words PW₀-PWₑ may be changed according to system requirements, and are not limited herein.

In one example, there is a (one-to-one) correspondence between the multiplicand words AW₀-AWₑ, the updated carry results Mc₀′-Mcₑ′ and the updated sum results Ms₀′-Msₑ′. In one example, there is a (one-to-one) correspondence between the modulus words PW₀-PWₑ, the updated carry results Sc₀′-Scₑ′ and the updated sum results Ss₀′-Ssₑ′.

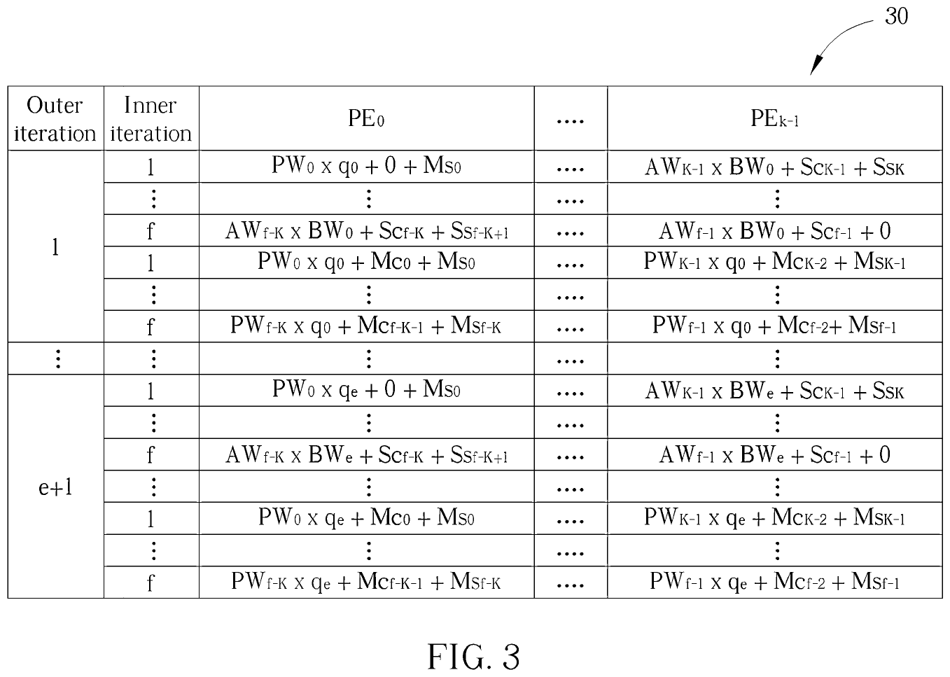

FIG. 3 is a table 30 of parallel processing of processing elements according to an example of the present invention. In detail, an element number K of the processing elements PE₀-PE_{K-1} is not greater than a word number (e+1) of the (e+1) multiplicand words AW₀-AWₑ. That is, a processing element of the processing elements PE₀-PE_{K-1} computes at least one of the updated carry results Mc₀′-Mcₑ′ and at least one of the updated sum results Ms₀-Msₑ′. In one example, a number f of the at least one of the updated carry results Mc₀′-Mcₑ′ and a number f of the at least one of the updated sum results Ms₀′-Msₑ′ are obtained according to the word number (e+1) and the element number K. For example, a processing element PE₀ computes updated carry results Mc₀′, Mc_{K}′, . . . , Mc_{f-K}′, wherein f=┌(e+1)/K┐. In one example, the processing elements PE₀-PE_{K-1} compute the updated carry results Mc₀′-Mcₑ′ and the updated sum results Ms₀′-Msₑ′ according to the element number, a plurality of element indices corresponding to the processing elements PE₀-PE_{K-1} and a plurality of word indices corresponding to the multiplicand words AW₀-AWₑ. In one example, a processing element PE_{K} corresponding to an element index k computes an updated carry result Mcⱼ′ and an updated sum result Msⱼ′ corresponding to an index j, wherein the element index k is equal to a remainder obtained by dividing the index j by the element number, i.e., k=j (mod K). In one example, at least two of the processing elements PE₀-PE_{K-1} compute at least two of the updated carry results Mc₀′-Mcₑ′ in parallel (e.g., simultaneously) according to the multiplier word BWᵢ and at least two multiplicand words of the (e+1) multiplicand words AW₀-AWₑ, and compute at least two of the updated sum results Ms₀′-Msₑ′ in parallel according to the multiplier word BWᵢ and the at least two multiplicand words. In one example, a number of the at least two of the processing elements PE₀-PE_{K-1}, a number of the at least two of the updated carry results Mc₀′-Mcₑ′ and a number of the at least two of the updated carry results Ms₀′-Msₑ′ are the same. Note that the at least two of the processing elements PE₀-PE_{K-1} may perform parallel computing at least one time. For example, processing elements PE₀-PE₁ compute updated carry results Mc₀′-Mc₁′ in parallel, and compute updated carry results Mc_{f-K}′-Mc_{f-K+1}′ in parallel.

In one example, an element number K of the processing elements PE_{K}-PE_{2K-1} is not greater than a word number (e+1) of the modulus words PW₀-PWₑ. That is, a processing element of the processing elements PE_{K}-PE_{2K-1} computes at least one of the updated carry results Sc₀′-Scₑ′ and at least one of the updated sum results Ss₀′-Ssₑ′. In one example, a number f of the at least one of the updated carry results Sc₀′-Scₑ′ and a number f of the at least one of the updated sum results Ss₀′-Ssₑ′ are obtained according to the word number (e+1) and the element number K. For example, a processing element PE_{K} computes updated carry results Sc₀′, Sc_{K}′, . . . , Sc_{f-K}′, wherein f=┌(e+1)/K┐. In one example, the processing elements PE_{K}-PE_{2K-1} compute the updated carry results Sc₀′-Scₑ′ and the updated sum results Ss₀′-Ssₑ′ according to the element number, a plurality of element indices corresponding to the processing elements PE_{K}-PE_{2K-1} and a plurality of word indices corresponding to the multiplicand words PW₀-PWₑ. In one example, a processing element PE_{K} corresponding to an element index k computes an updated carry result Scⱼ′ and an updated sum result Ssⱼ′ corresponding to an index j, wherein the element index k is equal to a remainder obtained by dividing the index j by the element number, i.e., k=j (mod K). In one example, at least two of the processing elements PE_{K}-PE_{2K-1} compute at least two of the updated carry results Sc₀′-Scₑ′ in parallel (e.g., simultaneously) according to at least two of the updated carry results Mc₀′-Mcₑ′ and at least two of the updated sum results Ms₀′-Msₑ′, and compute at least two of the updated sum results Ss₀′-Ssₑ′ in parallel. In one example, a number of the at least two of the processing elements PE_{K}-PE_{2K-1}, a number of the at least two of the updated carry results Sc₀′-Scₑ′ and a number of the at least two of the updated sum results Ss₀′-Ssₑ′ are the same. Note that the at least two of the processing elements PE_{K}-PE_{2K-1} may perform parallel computing at least one time. For example, processing elements PE_{K}-PE_{K+1} compute updated carry results Sc₀′-Sc₁′ in parallel, and compute updated carry results Sc₂′-Sc₃′ in parallel. Note that the K processing elements PE₀-PE_{K-1} and the K processing elements PE_{K}-PE_{2K-1} in FIG. 3 are assumed to be the same for simplifying the example, but are not limited herein.

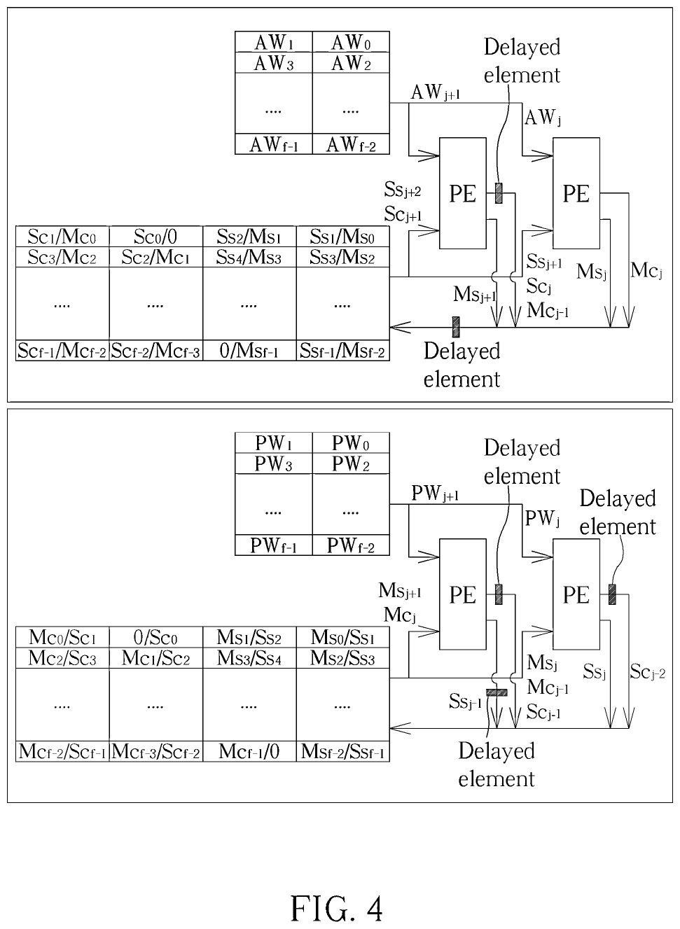

According to the above description, data flows of parallel processing of processing elements are shown in FIG. 4.

In one example, the processing elements PE₀-PE_{K-1} compute the updated carry results Mc₀′-Mcₑ′ and the updated sum results Ms₀′-Msₑ′ according to the plurality of multiplier words BW₀-BWₑ, the multiplicand words AW₀-AWₑ, the carry results Sc₀-Scₑ and (e+1) shifted sum results [symbol] ₀- [symbol] ₑ of the sum results Ss₀-Ssₑ (e.g., respectively). In one example, the shifted sum results [symbol] ₀- [symbol] ₑ are obtained by dividing the sum results Ss₀-Ssₑ by a radix 2^{w} (i.e., right-shifted by one word) (e.g., in a radix-2^{w} system). For example, [symbol] ⱼ=Ssⱼ₊₁. Note that a most significant shifted sum result [symbol] ₑ of the shifted sum results [symbol] ₀- [symbol] ₑ is 0. Practically, the shifted sum results [symbol] ₀- [symbol] ₑ may be obtained according to at least one delayed element, at least one flip flop or at least one register.

In one example, each of the updated carry results Mc₀′-Mcₑ′ and each of the updated sum results Ms₀′-Msₑ′ are computed according to the following instructions: multiplying a multiplicand word AWᵢ of the multiplicand words with the multiplier word BWᵢ of the multiplier words to obtain a multiplication, adding a carry result Scⱼ of the carry results Sc₀-Scₑ and a shifted sum result [symbol] ⱼ of the shifted sum results [symbol] ₀- [symbol] ₑ to the multiplication to obtain a number, dividing the number by a radix 2^{w} to obtain a quotient and a remainder, determining the quotient as an updated carry result Mcⱼ′ of the updated carry results Mc₀′-Mcₑ′, and determining the remainder as an updated sum result Msⱼ′ of the updated sum results Ms₀′-Msₑ′. Note that i is a multiplier word index. Thus, the above description can be stated according to the following equation:

$${AW}_{j} \times {BW}_{i} + {Sc}_{j} + {Ss}_{j + 1} = {Mc}_{j}^{′} {2}^{w} + {Ms}_{j}^{′} \qquad ( Eq . 1 )$$

In one example, the processing elements PE₀-PE_{K-1} are further configured to compute an extra quotient qᵢ according to a least significant result Ms₀′ of the updated sum results Ms₀′-Msₑ′ and an inverse word. The inverse word is a remainder of an inverse of a least significant word PW₀ of the modulus words PW₀-PWₑ divided by a radix 2^{w}. Thus, the computation of the extra quotient qᵢ can be stated according to the following equation:

$$( {Ms}_{0}^{′} \times ( - P {W}_{0}^{- 1} mod {2}^{w} ) ) mod {2}^{w} = {q}_{i} \qquad ( Eq . 2 )$$

In one example, there is a (one-to-one) correspondence between the extra quotient qᵢ and a multiplier word BWᵢ of the multiplier words BW₀-BWₑ, wherein the least significant result Ms₀′ is computed according to the multiplier word BWᵢ. In one example, the processing elements PE₀-PE_{K-1} compute the extra quotient qᵢ one time in (e.g., during) an iteration corresponding to the multiplier word BWᵢ. In one example, all of the carry results Sc₀-Scₑ and all of the sum results Ss₀-Ssₑ are initialized to 0.

In one example, the processing elements PE_{K}-PE_{2K-1} compute the updated carry results Sc₀′-Scₑ′ and the updated sum results Ss₀′-Ssₑ′ according to the extra quotient qᵢ, the modulus words PW₀-PWₑ, (e+1) shifted updated carry results [symbol] ₀′- [symbol] ₑ′ of the updated carry results Mc₀′-Mcₑ′ and the updated sum results Ms₀′-Msₑ′ (e.g., respectively). In one example, the shifted updated carry results [symbol] ₀′- [symbol] ₑ′ are obtained by multiplying the updated carry results Mc₀′-Mcₑ′ with a radix 2^{w} (i.e., left-shifted by one word). For example, [symbol] ⱼ′=Mcⱼ₋₁′. Note that a least significant carry result [symbol] ₀′ of the shifted updated carry results [symbol] ₀′- [symbol] ₑ′ is 0. Practically, the shifted updated carry results [symbol] ₀′- [symbol] ₑ′ may be obtained according to at least one delayed element, at least one flip flop or at least one register.

In one example, each of the updated carry results Sc₀′-Scₑ′ and each of the updated sum results Ss₀′-Ssₑ′ are computed according to the following instructions: multiplying a modulus word PWⱼ of the modulus words with an extra quotient qᵢ to obtain a multiplication, adding a shifted updated carry result [symbol] ⱼ′ of the shifted updated carry results [symbol] ₀′- [symbol] ₑ′ and a sum result Msⱼ′ of the updated sum results Ms₀′-Msₑ′ to the multiplication to obtain a number, dividing the number by a radix 2^{w} to obtain a quotient and a remainder, determining the quotient as an updated carry result Scⱼ′ of the updated carry results Sc₀′-Scₑ′, and determining the remainder as an updated sum result Ssⱼ′ of the updated sum results Ss₀′-Ssₑ′. The extra quotient qᵢ is generated according to a least significant result of the updated sum results Ms₀′-Msₑ′ and an inverse word, and the inverse word is a remainder of an inverse of a least significant word of the plurality of modulus words divided by the radix 2^{w}. Thus, the above description can be stated according to the following equation:

$${PW}_{j} \times {q}_{i} + {Mc}_{j - 1}^{′} + {Ms}_{j}^{′} = {Sc}_{j}^{′} {2}^{w} + {Ss}_{j}^{′} \qquad ( Eq . 3 )$$

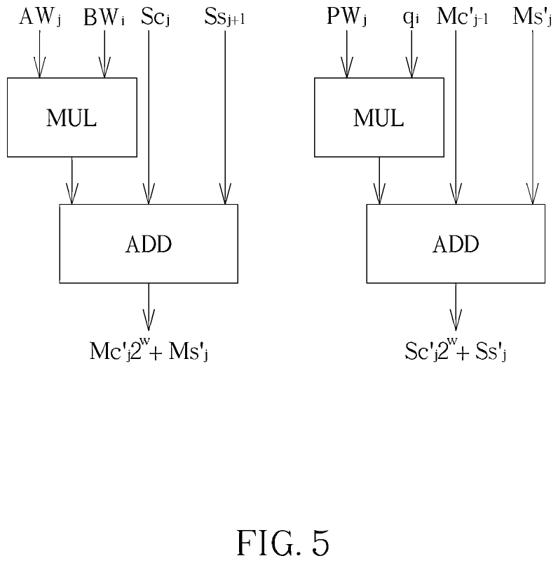

FIG. 5 are schematic diagrams of processing elements according to an example of the present invention. In detail, each of the processing elements PE₀-PE_{K-1} comprises a multiplier for multiplying the multiplicand word AWⱼ with the multiplier word BWᵢ, and an adder for adding the carry result Scⱼ, the shifted sum result [symbol] ⱼ and the multiplication. That is, the each of the processing elements PE₀-PE_{K-1} performs a multiply-and accumulation (MAC) operation. In addition, each of the processing elements PE_{K}-PE_{2K-1} comprises a multiplier for multiplying the modulus word PWⱼ with the extra quotient qᵢ, and an adder for adding the shifted updated carry result [symbol] ⱼ′, the sum result Msⱼ′ and the multiplication. That is, the each of the processing elements PE_{K}-PE_{2K-1} performs a MAC operation. Note that the computation of the extra quotient qᵢ in (Eq.2) may be performed by the multiplier in FIG. 5 or may be performed by an extra multiplier (not shown in FIG. 5).

According to the above description, the following equations can be obtained:

$$[ \begin{matrix}{AW}_{0} \\ {AW}_{1} \\ ⋮ \\ {AW}_{e}\end{matrix} ] {BW}_{i} + [ \begin{matrix}{Sc}_{0} \\ {Sc}_{1} \\ ⋮ \\ {Sc}_{e}\end{matrix} ] + [ \begin{matrix}{Ss}_{1} \\ {Ss}_{2} \\ ⋮ \\ 0\end{matrix} ] = [ \begin{matrix}{Mc}_{0}^{′} \\ {Mc}_{1}^{′} \\ ⋮ \\ {Mc}_{e}^{′}\end{matrix} ] {2}^{w} + [ \begin{matrix}{Ms}_{0}^{′} \\ {Ms}_{1}^{′} \\ ⋮ \\ {Ms}_{e}^{′}\end{matrix} ] \qquad ( Eq . 4 )$$

$$[ \begin{matrix}{PW}_{0} \\ {PW}_{1} \\ ⋮ \\ {PW}_{e}\end{matrix} ] {q}_{i} + [ \begin{matrix}0 \\ {Mc}_{1}^{′} \\ ⋮ \\ {Mc}_{e - 1}^{′}\end{matrix} ] + [ \begin{matrix}{Ms}_{0}^{′} \\ {Ms}_{1}^{′} \\ ⋮ \\ {Ms}_{e}^{′}\end{matrix} ] = [ \begin{matrix}{Sc}_{0}^{′} \\ {Sc}_{1}^{′} \\ ⋮ \\ {Sc}_{e}^{′}\end{matrix} ] {2}^{w} + [ \begin{matrix}{Ss}_{0}^{′} \\ {Ss}_{1}^{′} \\ ⋮ \\ {SS}_{e}^{′}\end{matrix} ] \qquad ( Eq . 5 )$$

In one example, the processing elements PE_{K}-PE_{2K-1} compute the carry results Sc₀-Scₑ and the sum results Ss₀-Ssₑ in a i-th iteration corresponding to a first word BWᵢ of the multiplier words. Then, the processing elements PE₀-PE_{K-1} compute the updated carry results Mc₀′-Mcₑ′ and the updated sum results Ms₀′-Msₑ′ in a (i+1)-th iteration corresponding to a second (e.g., next) word BWᵢ₊₁ of the multiplier words, and the processing elements PE_{K}-PE_{2K-1} compute the updated carry results Sc₀′-Scₑ′ and the updated sum results Ss₀′-Ssₑ′ in the second iteration.

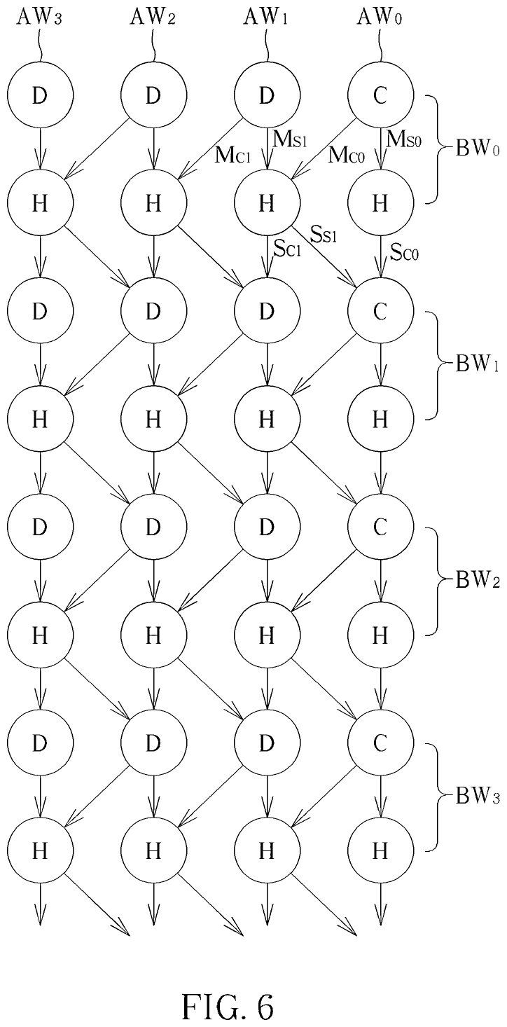

According to the above description, data dependency of carry results and sum results according to an example of the present invention are shown in FIG. 6. In FIG. 6, an operation performed by the processing element PE₀ is represented by a C task. Operations performed by the processing element PE₁-PE_{K-1} are represented by a D task. Operations performed by the processing element PE_{K}-PE_{2K-1} are represented by a H task. Note that a number of multiplicand words AW₀-AW₃, a number of multiplier words BW₀-BW₃ and a number of processing elements (i.e., 4) are assumed to be the same for simplifying the example, but are not limited herein.

In one example, the reduction element 210 computes the resulting remainder S, after the processing elements PE_{K}-PE_{2K-1} compute the updated carry results Sc₀′-Scₑ′ and the updated sum results Ss₀′-Ssₑ′ in a last iteration corresponding to a most significant word BWₑ of the multiplier words. In one example, the reduction element 210 computes the resulting remainder S according to a plurality of weightings corresponding to the updated carry results Sc₀′-Scₑ′ and a plurality of weightings corresponding to the updated sum results Ss₀′-Ssₑ′. For example, a weighting 2^{jw} is corresponding to an updated carry result Scⱼ′ and an updated sum result Ssⱼ₊₁′. Thus, the above description can be stated according to the following equation:

$$S = [ \begin{matrix}{Sc}_{0} \\ {Sc}_{1} \\ ⋮ \\ {Sc}_{e}\end{matrix} ] + [ \begin{matrix}{Ss}_{1} \\ {Ss}_{2} \\ ⋮ \\ 0\end{matrix} ] \qquad ( Eq . 6 )$$

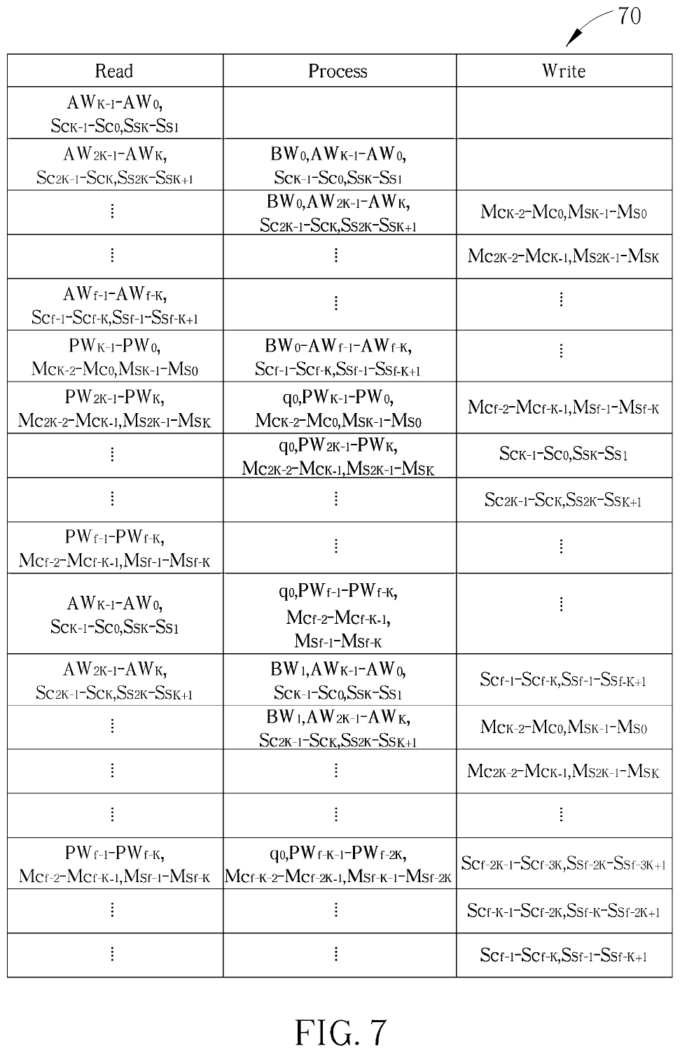

FIG. 7 is a schedule table 70 of operations of a modular multiplication according to an example of the present invention. In detail, the processing elements PE₀-PE_{K-1} compute the updated carry results Mc₀′-Mcₑ′ and the updated sum results Ms₀′-Msₑ′, after accessing (e.g., reading) the multiplicand words AW₀-AWₑ, the carry results Sc₀-Scₑ and the sum results Ss₀-Ssₑ (e.g., loaded, stored) in the at least one storage device 220. The processing elements PE_{K}-PE_{2K-1} compute the updated carry results Sc₀′-Scₑ′ and the updated sum results Ss₀′-Ssₑ′, after accessing the modulus words PW₀-PWₑ, the updated carry results Mc₀′-Mcₑ′ and the updated sum results Ms₀′-Msₑ′ in the at least one storage device 220. The reduction element 210 computes the resulting remainder S, after accessing the updated carry results Sc₀′-Scₑ′ and the updated sum results Ss₀′-Ssₑ′ in the at least one storage device 220. In addition, the processing elements PE₀-PE_{K-1} store (e.g., write) the updated carry results Mc₀′-Mcₑ′ and the updated sum results Ms₀′-Msₑ′ in the at least one storage device 220 in a first order, after computing the updated carry results Mc₀′-Mcₑ′ and the updated sum results Ms₀′-Msₑ′. The processing elements PE_{K}-PE_{2K-1} store the updated carry results Sc₀′-Scₑ′ and the updated sum results Ss₀′-Ssₑ′ in the at least one storage device 220 in a second order, after computing the updated carry results Sc₀′-Scₑ′ and the updated sum results Ss₀′-Ssₑ′. Then, the reduction element 210 stores the resulting remainder S in the at least one storage device 220, after computing the resulting remainder S. Note that orders for storing iterative sum results and iterative carry results in FIG. 7 may be changed according to system requirements, and are not limited herein.

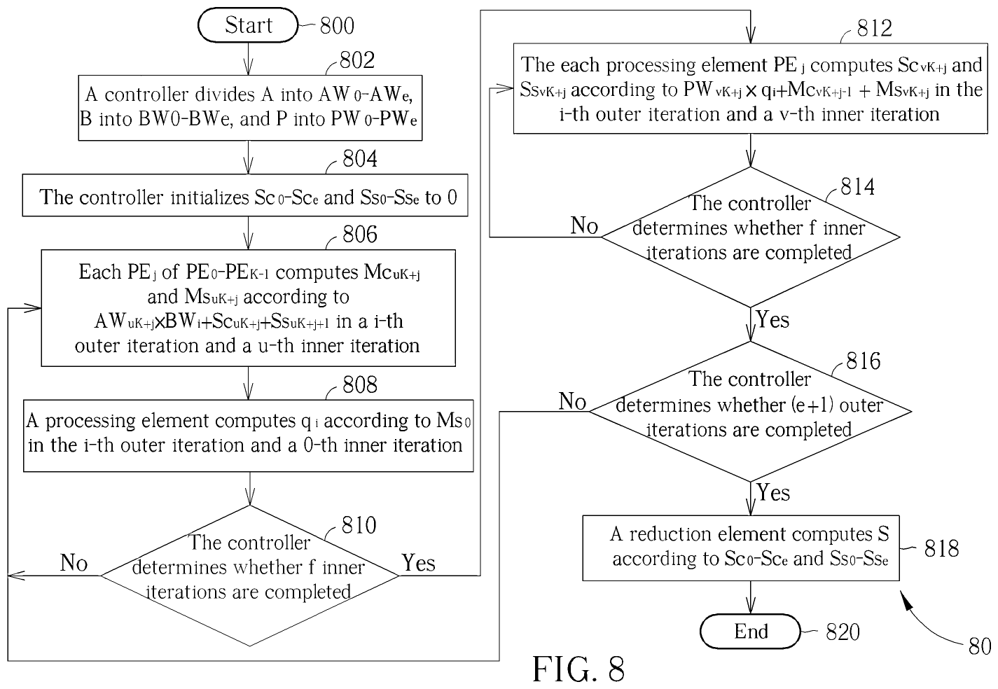

Operations of the modular operation device in the above examples can be summarized into a process 80 shown in FIG. 8, and can be compiled into the program codes 114. The process 80 includes the following steps:
Step 800: Start.
Step 802: A controller divides A into AW₀-AWₑ, B into BW₀-BWₑ, and divides P into PW₀-PWₑ.
Step 804: The controller initializes Sc₀-Scₑ and Ss₀-Ssₑ to 0.
Step 806: Each processing element PEⱼ of PE₀-PE_{K-1} computes Mc_{uK+j} and Ms_{uK+j} according to AW_{uK+j}×BWᵢ+Sc_{uK+j}+Ss_{uK+j+1} in a i-th outer iteration and a u-th inner iteration.
Step 808: A processing element PE₀ computes qᵢ according to Ms₀ in the i-th outer iteration and a 0-th inner iteration.
Step 810: The controller determines whether f inner iterations are completed. If yes, perform Step 812, otherwise, perform Step 806.
Step 812: The each processing element PEⱼ computes Sc_{vK+j} and Ss_{vK+j} according to PW_{vK+j}×qᵢ+Mc_{vK+j-1}+Ms_{vK+j} in the i-th outer iteration and a v-th inner iteration.
Step 814: The controller determines whether f inner iterations are completed. If yes, perform Step 816, otherwise, perform Step 812.
Step 816: The controller determines whether (e+1) outer iterations are completed. If yes, perform Step 818, otherwise, perform Step 806.
Step 818: A reduction element computes S according to Sc₀-Scₑ and Ss₀-Ssₑ.
Step 820: End.

Detailed operations and variations of the process 80 can be referred to the above illustration, and are not narrated herein.

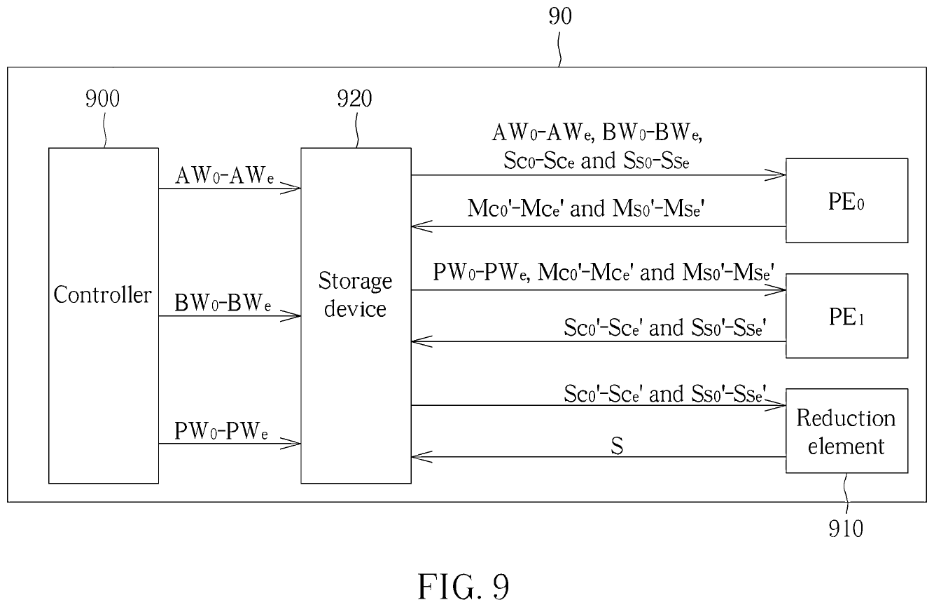

FIG. 9 is a schematic diagram of operations of a modular operation device 90 according to an example of the present invention. In FIG. 9, the modular operation device 90 comprises two processing elements PE₀-PE₁, a controller 900, a reduction element 910 and at least one storage device 920. The controller 900 is coupled to the processing elements PE₀-PE₁, the reduction element 910 and the at least one storage device 920.

In detail, the modular operation device 90 is (used) for computing a modular multiplication (i.e., remainder) of a multiplicand A and a multiplier B with respect to a modulus P based on a Montgomery multiplication algorithm. The controller 900 is configured to divide the multiplicand A into (e+1) multiplicand words AW₀-AWₑ, the multiplier B into (e+1) multiplier words BW₀-BWₑ, and the modulus P into (e+1) modulus words PW₀-PWₑ, wherein e≥1. The processing element PE₀ is configured to compute the extra quotient qᵢ, (e+1) updated carry results Mc₀′-Mcₑ′ and (e+1) updated sum results Ms₀′-Msₑ′ according to one multiplier word of the multiplier words BW₀-BWₑ, the multiplicand words AW₀-AWₑ, (e+1) carry results Sc₀-Scₑ and (e+1) sum results Ss₀-Ssₑ (e.g., respectively). The processing element PE₁ is configured to compute (e+1) updated carry results Sc₀′-Scₑ′ and (e+1) updated sum results Ss₀′-Ssₑ′ according to the extra quotient qᵢ, the modulus words PW₀-PWₑ, the updated carry results Mc₀′-Mcₑ′ and the updated sum results Ms₀′-Msₑ′ (e.g., respectively). Then, the reduction element 910 is configured to compute a resulting remainder S according to the updated carry results Sc₀-Scₑ′ and the updated sum results Ss₀′-Ssₑ′. That is, a two-step method is used for computing carry results and sum results. Thus, the problem regarding computing of iterative carry results and sum results is solved.

In one example, the processing elements PE₀-PE₁ are the same.

Detailed operations and variations of the process 90 can be referred to the above illustration, and are not narrated herein.

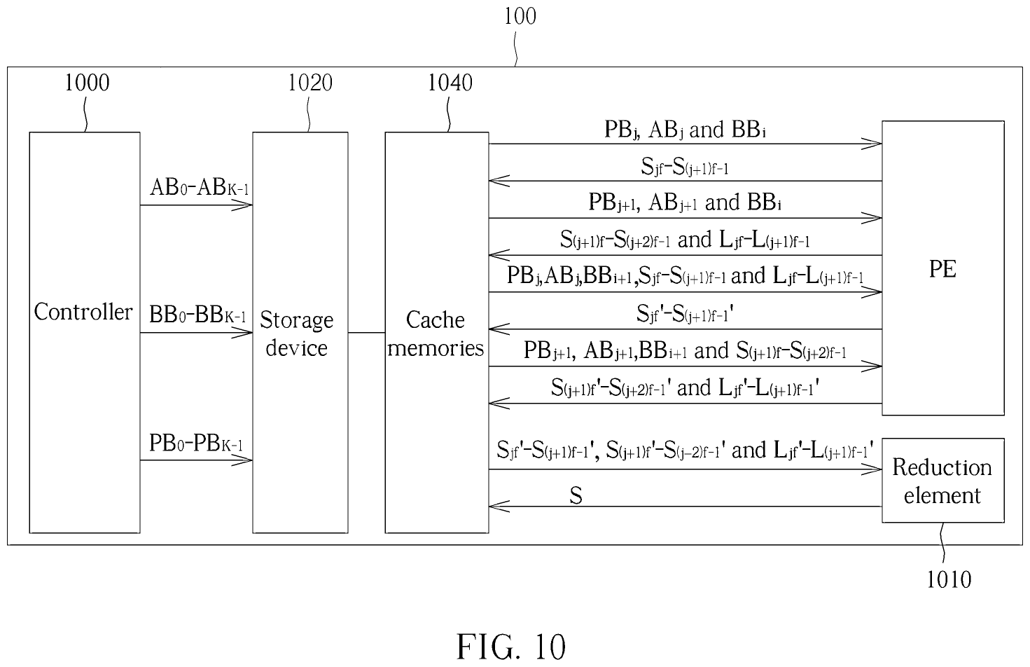

FIG. 10 is a schematic diagram of operations of a modular operation device 100 according to an example of the present invention. In FIG. 10, the modular operation device 100 comprises a processing element PE, a controller 1000, a reduction element 1010, at least one storage device (e.g., main memory) 1020 and a plurality of cache memories 1040. The controller 1000 is coupled to the processing element PE, the reduction element 1010, the at least one storage device 1020 and the plurality of cache memories 1040.

In detail, the modular operation device 100 is (used) for computing a modular multiplication (i.e., remainder) of a multiplicand A and a multiplier B with respect to a modulus P based on a Montgomery multiplication algorithm. The controller 1000 is configured to divide the multiplicand A into K multiplicand blocks AB₀-AB_{K-1}, the multiplier B into K multiplier blocks BB₀-BB_{K-1}, and the modulus P into K modulus blocks PB₀-PB_{K-1}, wherein K≥2. The processing element PE is configured to execute instructions. The instructions comprise computing f sum results S_{jf}-S_{(j+1)f-1} according to a multiplicand block ABⱼ of the multiplicand blocks AB₀-AB_{K-1}, a modulus block PBⱼ of the modulus blocks PB₀-PB_{K-1} and a multiplier block BBᵢ of the multiplier blocks BB₀-BB_{K-1}, wherein f≥2. The instructions comprise computing f sum results S_{(j+1)f}-S_{(j+2)f-1} and f delayed sum results L_{jf}-L_{(j+1)f-1} according to a multiplicand block ABⱼ₊₁ of the multiplicand blocks AB₀-AB_{K-1}, a modulus block PBⱼ₊₁ of the modulus blocks PB₀-PB_{K-1} and the multiplier block BBᵢ. The instructions comprise computing f updated sum results S_{jf}′-S_{(j+1)f-1}′ according to the sum results S_{jf}-S_{(j+1)f-1}, the delayed sum results L_{jf}-L_{(j+1)f-1}, the multiplicand block ABⱼ, the modulus block PBⱼ and a multiplier block BBᵢ₊₁ of the multiplier blocks BB₀-BB_{K-1}. The instructions comprise computing f updated sum results S_{(j+1)f}′-S_{(j+2)f-1}′ and f updated delayed sum results L_{jf}′-L_{(j+1)f-1}′ according to the sum results S_{(j+1)f}-S_{(j+2)f-1}, the multiplicand block ABⱼ₊₁, the modulus block PBⱼ₊₁ and the multiplier block BBᵢ₊₁. Then, the reduction element 1010 is configured to compute a resulting remainder S according to the updated sum results S_{jf}′-S_{(j+1)f-1}′, updated sum results S_{(j+1)f}′-S_{(j+2)f-1}′ and the updated delayed sum results L_{jf}′-L_{(j+1)f-1}′. That is, a post processing method is used for computing carry results and sum results. Thus, the problem regarding computing of iterative carry results and sum results is solved.

In one example, the processing element PE computes the delayed sum results L_{jf}-L_{(j+1)f-1} according to the multiplicand block ABⱼ₊₁, the modulus block PBⱼ₊₁, the multiplier block BBᵢ and f extra quotients q_{if}-q_{(i+1)f-1}.

In one example, the multiplicand A is an n-bit integer. In one example, each of the multiplicand blocks AB₀-AB_{K-1} is a b-bit integer, and comprises f multiplicand words. In one example, each of the multiplicand words is a w-bit integer, i.e., K=┌n/b┐ and f=┌b/w┐. Note that block numbers and bit lengths of the multiplicand blocks AB₀-AB_{K-1}, the multiplier words BB₀-BB_{K-1} and the modulus words PB₀-PB_{K-1} may be changed according to system requirements, and are not limited herein.

In one example, there is a (one-to-one) correspondence between the sum results S_{jf}-S_{(j+1)f-1}, the updated sum results S_{jf}′-S_{(j+1)f-1}′ and f multiplicand words AW_{jf}-AW_{(j+1)f-1} of the multiplicand block ABⱼ. In one example, there is a (one-to-one) correspondence between the sum results S_{(j+1)f}-S_{(j+2)f-1}, the updated sum results S_{(j+1)f}′-S_{(j+2)f-1}′ and f multiplicand words AW_{(j+1)f}-AW_{(j+2)f-1} of the multiplicand block ABⱼ₊₁.

In one example, there is a correspondence between the delayed sum results L_{jf}-L_{(j+1)f-1} and the sum results S_{jf}-S_{(j+1)f-1}. In one example, a number of the delayed sum results L_{jf}-L_{(j+1)f-1} and a number of the sum results S_{jf}-S_{(j+1)f-1} are the same. In one example, the number of the delayed sum results L_{jf}-L_{(j+1)f-1} is smaller than the number of the sum results S_{jf}-S_{(j+1)f-1}. In one example, there is a correspondence between the delayed sum results L_{jf}-L_{(j+1)f-1} and f multiplier words BW_{if}-BW_{(i+1)f-1} of the multiplier block BBᵢ. In one example, there is a correspondence between the updated delayed sum results L_{jf}′-L_{(j+1)f-1}′ and f multiplier words BW_{(i+1)f}-BW_{(i+2)f-1} of the multiplier block BBᵢ₊₁.

In one example, the modular operation device 100 further comprises a loading and storing element coupled to the controller 1000. The loading and storing element is configured to execute instructions. The instructions comprise loading (e.g., copying) the multiplicand block ABⱼ and the modulus block PBⱼ from the at least one storage device 1020 to the plurality of cache memories 1040 (i.e., the multiplicand block ABⱼ and the modulus block PBⱼ are loaded from the storage device, and is stored in the cache memories), before the processing element computes the sum results S_{jf}-S_{(j+1)f-1}. The instructions comprise loading the multiplicand block ABⱼ₊₁ and the modulus block PBⱼ₊₁ from the at least one storage device 1020 to the plurality of cache memories 1040, before the processing element computes the sum results S_{(j+1)f}-S_{(j+2)f-1} and the delayed sum results L_{jf}-L_{(j+1)f-1}. The instructions comprise loading the sum results S_{jf}-S_{(j+1)f-1}, the delayed sum results L_{jf}-L_{(j+1)f-1} and the multiplicand block ABⱼ and the modulus block PBⱼ from the at least one storage device 1020 to the plurality of cache memories 1040, before the processing element computes the updated sum results S_{jf}′-S_{(j+1)f-1}′. The instructions comprise loading the sum results S_{(j+1)f}-S_{(j+2)f-1}, the multiplicand block ABⱼ₊₁ and the modulus block PBⱼ₊₁ from the at least one storage device 1020 to the plurality of cache memories 1040, before the processing element computes the updated sum results S_{(j+1)f}′-S_{(j+2)f-1}′ and the updated delayed sum results L_{jf}′-L_{(j+1)f-1}′. In one example, the processing element computes the sum results S_{jf}-S_{(j+1)f-1}, after accessing (e.g., reading) the multiplicand block ABⱼ (e.g., loaded) in the plurality of cache memories 1040. The processing element computes sum results S_{(j+1)f}-S_{(j+2)f-1} and the delayed sum results L_{jf}-L_{(j+1)f-1}, after accessing the multiplicand block ABⱼ₊₁ in the plurality of cache memories 1040. The processing element computes the updated sum results S_{jf}′-S_{(j+1)f-1}′, after accessing the sum results S_{jf}-S_{(j+1)f-1}, the delayed sum results L_{jf}-L_{(j+1)f-1} and the multiplicand block ABⱼ in the plurality of cache memories 1040. The processing element computes the updated sum results S_{(j+1)f}′-S_{(j+2)f-1}′, after accessing the sum results S_{(j+1)f}-S_{(j+2)f-1} and the multiplicand block ABⱼ₊₁ in the plurality of cache memories 1040. That is, data (e.g., multiplicand words of the multiplicand block) for computations in each block are loaded to the cache memories only for one time. In other words, occurrences of cache misses are reduced.

In one example, the processing element is configured to execute instructions. The instructions comprise storing (e.g., writing) the sum results S_{jf}-S_{(j+1)f-1} in the plurality of cache memories 1040, after computing the sum results S_{jf}-S_{(j+1)f-1}. The instructions comprise storing the sum results S_{(j+1)f}-S_{(j+2)f-1} and the delayed sum results L_{jf}-L_{(j+1)f-1} in the plurality of cache memories 1040, after computing the sum results S_{(j+1)f}-S_{(j+2)f-1} and the delayed sum results L_{jf}-L_{(j+1)f-1}. The instructions comprise storing the updated sum results S_{jf}′-S_{(j+1)f-1}′ in the plurality of cache memories 1040, after computing the updated sum results S_{jf}′-S_{(j+1)f-1}′. The instructions comprise storing the updated sum results S_{(j+1)f}′-S_{(j+2)f-1}′ in the plurality of cache memories 1040, after computing the updated sum results S_{(j+1)f}′-S_{(j+2)f-1}′. In one example, the loading and storing element is configured to execute instructions. The instructions comprise storing the sum results S_{jf}-S_{(j+1)f-1} in the at least one storage device 1020, after the processing element computes the sum results S_{jf}-S_{(j+1)f-1}. The instructions comprise storing the sum results S_{(j+1)f}-S_{(j+2)f-1} and the delayed sum results L_{jf}-L_{(j+1)f-1} in the at least one storage device 1020, after the processing element computes the sum results S_{(j+1)f}-S_{(j+2)f-1} and the delayed sum results L_{jf}-L_{(j+1)f-1}. The instructions comprise storing the updated sum results S_{jf}′-S_{(j+1)f-1}′ in the at least one storage device 1020, after the processing element computes the updated sum results S_{jf}′-S_{(j+1)f-1}′. The instructions comprise storing the updated sum results S_{(j+1)f}′-S_{(j+2)f-1}′ in the at least one storage device 1020, after the processing element computes the updated sum results S_{(j+1)f}′-S_{(j+2)f-1}′.

In one example, the loading and storing element is further configured to execute instructions. The instructions comprise loading the multiplicand block ABⱼ and the modulus block PBⱼ to a first cache memory of the plurality of cache memories 1040. The instructions comprise loading the multiplicand block ABⱼ₊₁ and the modulus block PBⱼ₊₁ to a second cache memory of the plurality of cache memories 1040, when the processing element computes the sum results S_{jf}-S_{(j+1)f-1}. The instructions comprise loading the sum results S_{jf}-S_{(j+1)f-1}, the delayed sum results L_{jf}-L_{(j+1)f-1}, the multiplicand block ABⱼ and the modulus block PBⱼ to the first cache memory, when the processing element computes the sum results S_{(j+1)f}-S_{(j+2)f-1} and the delayed sum results L_{jf}-L_{(j+1)f-1}. The instructions comprise loading the sum results S_{(j+1)f}-S_{(j+2)f-1}, the multiplicand block ABⱼ₊₁ and the modulus block PBⱼ₊₁ to the second cache memory, when the processing element computes the updated sum results S_{jf}′-S_{(j+1)f-1}′.

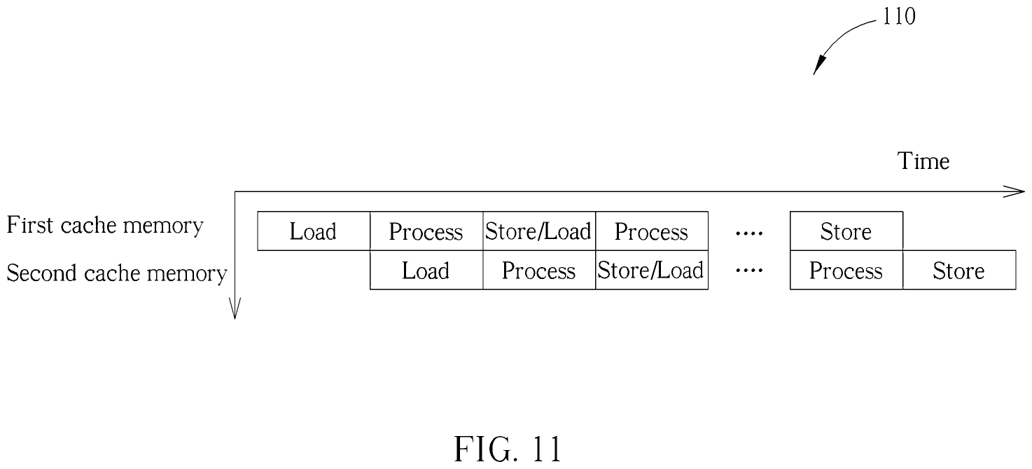

FIG. 11 is a schedule table 110 of operations of a modular multiplication according to an example of the present invention. In detail, the loading and storing element loads the multiplicand block ABⱼ, the modulus block PBⱼ to the first cache memory, before the processing element computes sum results S_{jf}-S_{(j+1)f-1}. The loading and storing element loads the multiplicand block ABⱼ₊₁, the modulus block PBⱼ₊₁ to the second cache memory, when the processing element computes the sum results S_{jf}-S_{(j+1)f-1}. The loading and storing element stores the sum results S_{jf}-S_{(j+1)f-1} (e.g., stored) in the first cache memory in the at least one storage device 1020, when the processing element computes the sum results S_{(j+1)f}-S_{(j+2)f-1} and the delayed sum results L_{jf}-L_{(j+1)f-1}. The loading and storing element loads the multiplicand block ABⱼ and the modulus block PBⱼ to the first cache memory, before the processing element computes sum results S_{jf}-S_{(j+1)f-1}. The loading and storing element loads the multiplicand block ABⱼ₊₁ and PBⱼ₊₁ to the second cache memory, when the processing element computes the sum results S_{jf}′-S_{(j+1)f-1}′. The loading and storing element stores the sum results S_{(j+1)f}-S_{(j+2)f-1} and the delayed sum results L_{jf}-L_{(j+1)f-1} in the second cache memory in the at least one storage device 1020, when the processing element computes the updated sum results S_{jf}′-S_{(j+1)f-1}′. The loading and storing element stores the updated sum results S_{jf}′-S_{(j+1)f-1}′ in the first cache memory in the at least one storage device 1020, when the processing element computes the updated sum results S_{(j+1)f}′-S_{(j+2)f-1}′. The loading and storing element stores the updated sum results S_{(j+1)f}′-S_{(j+2)f-1}′ in the second cache memory in the at least one storage device 1020. That is, a Ping-Pong cache memory (e.g., Ping-Pong buffer) is used for computing sum results in the modular multiplication.

In one example, the processing element is further configured to execute instructions. The instructions comprise computing f delayed carry results H_{if}-H_{(i+1)f-1} according to a most significant word AW_{(j+1)f-1} of the multiplicand block ABⱼ and the multiplier block BBᵢ. The instructions comprise computing f delayed carry results H_{(i+1)f}-H_{(i+2)f-1} according to the most significant word AW_{(j+1)f-1} and the multiplier block BBᵢ₊₁. In one example, the reduction element is further configured to execute instructions of: computing the resulting remainder S according to the updated sum results Ms₀′-Msₑ′, the updated sum results Ss₀′-Ssₑ′, the updated delayed sum results L_{jf}′-L_{(j+1)f-1}′, the delayed carry results H_{if}-H_{(i+1)f-1} and the delayed carry results H_{(i+1)f}-H_{(i+2)f-1}. In one example, the processing element computes the delayed sum results L_{jf}-L_{jf+f-1} according to a least significant word AW_{(j+1)f} of the multiplicand block ABⱼ₊₁ and the multiplier block BBᵢ, and computes the updated delayed sum results L_{jf}′-L_{jf+f-1}′ according to the least significant word AW_{(j+1)f} and the multiplier block BBᵢ₊₁. In one example, the processing element computes the delayed sum results L_{jf}-L_{(j+1)f-1} (e.g., only) according to the least significant word AW_{(j+1)f}, the multiplier block BBᵢ, PB_{(j+1)f}, f extra quotients q_{if}-q_{(i+1)f-1} and a first plurality of temporary carry results. The processing element computes the updated delayed sum results L_{jf}′-L_{jf+f-1}′ (e.g., only) according to the least significant word AW_{(j+1)f}, the multiplier block BBᵢ₊₁ and a second plurality of temporary carry results, wherein the first plurality of temporary carry results and the second plurality of temporary carry results are computed according to a second least significant word AW_{(j+1)f+1} of the multiplicand block ABⱼ₊₁. For example, the processing element does not compute the delayed sum results L_{jf}-L_{(j+1)f-1} according to the delayed carry results H_{if}-H_{(i+1)f-1} computed according to the most significant word AW_{(j+1)f-1} of the multiplicand block ABⱼ. The processing element does not compute the updated delayed sum results L_{jf}′-L_{jf+f-1}′ according to the delayed carry results H_{(i+1)f}-H_{(i+2)f-1} computed according to the most significant word AW_{(j+1)f-1}.

In one example, the processing element is further configured to execute instructions. The instructions comprise computing a delayed carry result H_{(i+1)f-1} according to a most significant word AW_{(j+1)f-1} of the multiplicand block ABⱼ and a most significant word BW_{(i+1)f-1} of the multiplier block BBᵢ, determining the delayed carry result H_{(i+1)f-1} as a most significant result S_{(j+1)f-1} of the sum results S_{jf}-S_{(j+1)f-1}. The instructions comprise computing a delayed carry result H′_{(i+1)f-1} according to a most significant word AW_{(j+2)f-1} of the multiplicand block ABⱼ₊₁ and the most significant word BW_{(i+1)f-1}, and determining the delayed carry result H′_{(i+1)f-1} as a most significant result S_{(j+2)f-1} of the sum results S_{(j+1)f}-S_{(j+2)f-1}.

In one example, the instruction of computing the updated sum results S_{jf}′-S_{(j+1)f-1}′ comprises computing a plurality of temporary sum results according to the sum results S_{jf}-S_{(j+1)f-1}, the delayed sum results L_{jf}-L_{(j+1)f-1}, the multiplicand block ABⱼ and a first word of the multiplicand block BBᵢ₊₁, and computing the updated sum results S_{jf}′-S_{(j+1)f-1}′ according to the plurality of temporary sum results, the multiplicand block ABⱼ and a second word of the multiplier block BBᵢ₊₁. In one example, the first word of the multiplier block BBᵢ₊₁ is a least significant word BW_{(i+1)f} of the multiplier block BBᵢ₊₁ (i.e., preprocess of iterative sum results and iterative delayed sum results).

In one example, the processing element is further configured to execute an instruction of: computing an extra quotient q_{if+u} according to a least significant result S₀ of the sum results S₀-S_{f-1}, a least significant result L₀ of the delayed sum results L₀-L_{f-1} and an inverse word in an iteration corresponding to a word BB_{if+u} of the multiplier block BBᵢ, wherein the inverse word is a remainder of an inverse of a least significant word PW₀ of a least significant modulus block PB₀ of the modulus blocks PB₀-PB_{K-1} divided by a radix 2^{w}.

In one example, there is a correspondence between the extra quotient block qBᵢ and a multiplier block BBᵢ of the multiplier blocks BB₀-BB_{K-1}, wherein the least significant result S_{jf} is computed according to the multiplier block BBᵢ. In one example, the processing element computes the extra quotient block qBᵢ one time in an iteration corresponding to the multiplier block BBᵢ.

According to the above description, an example of a pseudo code can be obtained as follows:

```
Initialize S to 0.
Initialize carry out results L, L_n, Ca and Cb to 0.
  for (i = 0:k − 1) begin
Perform a block_0 process. // Process a least significant block.
    for (j = 1:k − 1) begin
Perform at least one block_1 process. // Process other blocks.
    end
Determine L_n as L_{(k-1)f}.
Determine Ca[k − 1] as L_n .
Determine Cb[k − 2:0] as Ca[k − 2:0] .
  end
  // Post process of S + L.
Determine 0 as Cc and Ca[−1].
  for (i = 0:k − 1) begin
Compute Cc and Sⱼ according to Sⱼ + Lⱼ + Ca[i − 1] + Cc .
    for (j = 0:f − 1) begin
Compute Cc and Sⱼ according to Sⱼ + Lⱼ + Cc.
    end
  end
Determine Cc + L_n as S_{fk}.
```

Ca[k−1] is a (k−1)-th bit of Ca, and Cb[k−2:0] is a segment with a most significant bit (k−2) and a least significant bit 0.

In addition, the block_0 process can be obtained as follows:

```
Initialize Cb[0] to 0.
  for (v = 0:f − 1) begin
Compute Cb[0] and Sᵥ according to Sᵥ + Lᵥ + Cb[0].
  end
  for (u = 0:f − 1) begin
  // X task
Determine AW₀ × BW_{if+u} + S₀ as T.
Determine T[w − 1:0] as S₀.
Determine T[2w − 1:w] as Mc.
Determine S₀ × t as q_{jf+u}.
Determine PW₀ × q_{if+u} + S₀ as T′.
Determine T′[2w − 1:w] as Sc.
  for (v = 1:f − 1) begin // Y task
Determine AWᵥ × BW_{if+u} + Sᵥ + Mc as T.
Determine T[w − 1:0] as Sᵥ.
Determine T[2w − 1:w] as Mc.
Determine PWᵥ × q_{if+u} + Sᵥ + Sc as T′.
Determine T′[w − 1:0] as Sᵥ₋₁.
Determine T′[2w − 1:w] as Sc.
  end
Compute Cb[0] and S_{f-1} according to Cb[0] + Mc + Sc.
  end
```

In addition, the block_1 process can be obtained as follows:

```
Initialize Cb[j] to Ca[j − 1].
  for (v = 0:f − 1) begin
Compute Cb[j] and S_{jf+v} according to S_{jf+v} + L_{jf+v} + Cb[j].
  end
  for (u = 0:f − 1) begin
  // X task
Determine AW_{jf} × BW_{if+u} + S_{jf} as T.
Determine T[w − 1:0] as S_{jf}.
Determine T[2w − 1:w] as Mc.
Determine PW_{jf} × q_{if+u} + S_{jf} as T′.
Determine T′[w − 1:0] as L_{(j-1)f+u}.
Determine T′[2w − 1:w] as Sc.
  for (v = 1:f − 1) begin // Y task
Determine AW_{jf+v} × BW_{if+u} + S_{jf+v} + Mc as T.
Determine T[w − 1:0] as S_{jf+v}.
Determine T[2w − 1:w] as Mc.
Determine PW_{jf+v} × q_{if+u} + S_{jf+v} + Sc as T′.
Determine T′[w − 1:0] as S_{jf+v-1}.
Determine T′[2w − 1:w] as Sc.
  end
Compute Cb[j] and S_{jf+f-1} according to Cb[j] + Mc + Sc.
  end
```

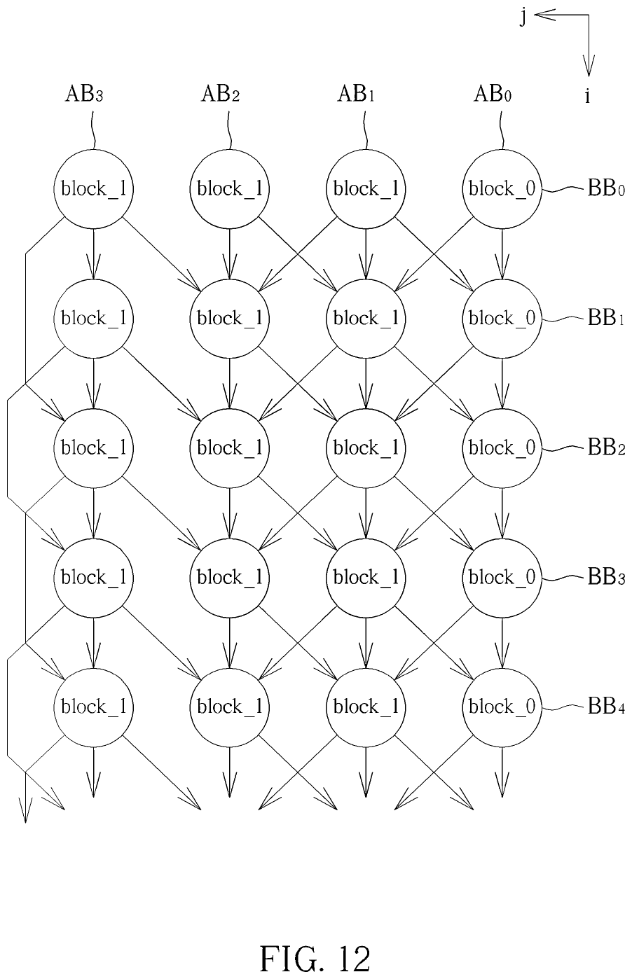

According to the above description, data dependency of carry results and sum results according to an example of the present invention are shown in FIG. 12. Note that a number of multiplicand blocks AW₀-AW₃ and a number of multiplier blocks BW₀-BW₄ are not limited herein.

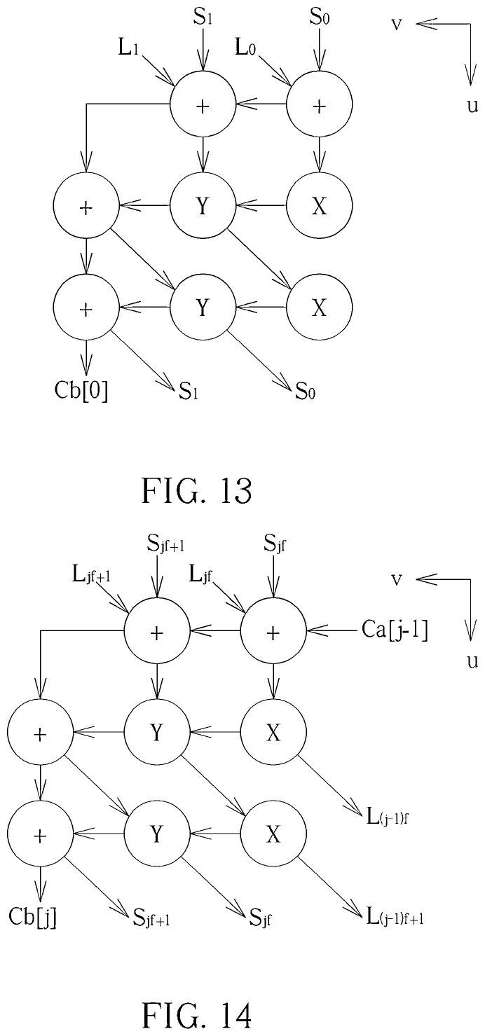

In detail, data dependency of carry results and sum results in a block_0 process are shown in FIG. 13. In addition, data dependency of carry results and sum results in a block_1 process are shown in FIG. 14.

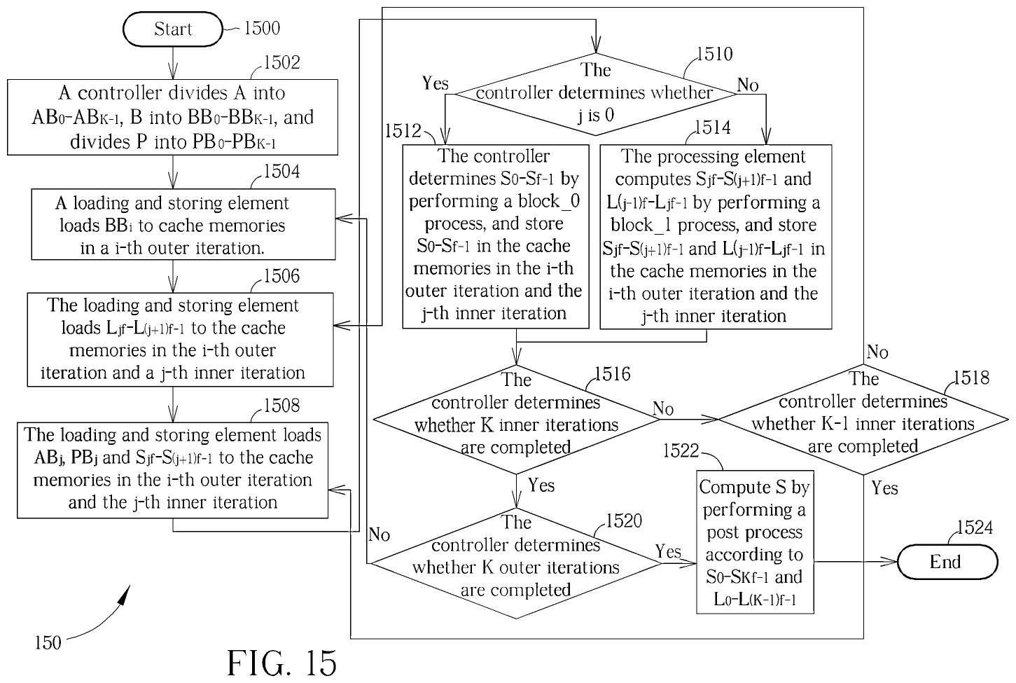

Operations of the modular operation device in the above examples can be summarized into a process 150 shown in FIG. 15, and can be compiled into the program codes 114. The process 150 includes the following steps:
Step 1500: Start.
Step 1502: A controller divides A into AB₀-AB_{K-1}, B into BB₀-BB_{K-1}, and divides P into PB₀-PB_{K-1}.
Step 1504: A loading and storing element loads BBᵢ to cache memories in a i-th outer iteration.
Step 1506: The loading and storing element loads L_{jf}-L_{(j+1)f-1} to the cache memories in the i-th outer iteration and a j-th inner iteration.
Step 1508: The loading and storing element loads ABⱼ, PBⱼ and S_{jf}-S_{(j+1)f-1} to the cache memories in the i-th outer iteration and the j-th inner iteration.
Step 1510: The controller determines whether j is 0. If yes, perform Step 1512, otherwise, perform Step 1514.
Step 1512: A processing element computes S₀-S_{f-1} by performing a block_0 process, and stores S₀-S_{f-1} in the cache memories in the i-th outer iteration and the j-th inner iteration. Perform Step 1516.
Step 1514: The processing element computes S_{jf}-S_{(j+1)f-1} and L_{(j-1)f}-L_{jf-1} by performing a block_1 process, and stores S_{jf}-S_{(j+1)f-1} and L_{(j-1)f}-L_{jf-1} in the cache memories in the i-th outer iteration and the j-th inner iteration.
Step 1516: The controller determines whether K inner iterations are completed. If yes, perform Step 1520, otherwise, perform Step 1518.
Step 1518: The controller determines whether (K−1) inner iterations are completed. If yes, perform Step 1508, otherwise, perform Step 1506.
Step 1520: The controller determines whether K outer iterations are completed. If yes, perform Step 1522, otherwise, perform Step 1504.
Step 1522: A reduction element computes S by performing a post process according to S₀-S_{Kf-1} and L₀-L_{(K-1)f-1}.
Step 1524: End.

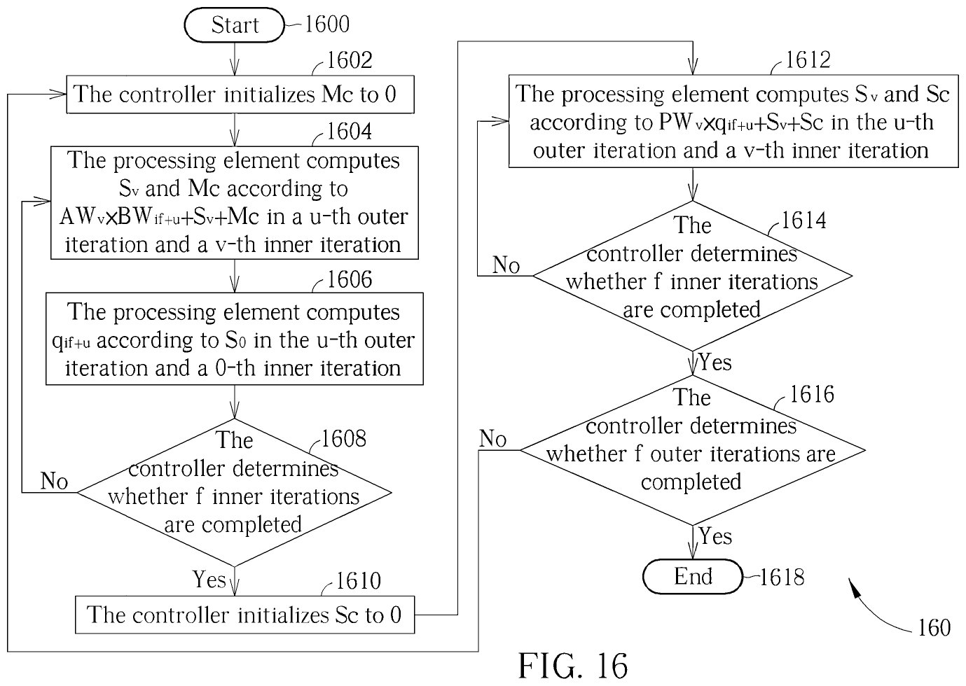

The block_0 process of Step 1512 in FIG. 15 may be realized by a process 160 shown in FIG. 16. The process 160 includes the following steps:
Step 1600: Start.
Step 1602: The controller initializes Mc to 0.
Step 1604: The processing element computes Sᵥ and Mc according to AWᵥ×BW_{if+u}+Sᵥ+Mc in a u-th outer iteration and a v-th inner iteration.
Step 1606: The processing element computes q_{if+u} according to S₀ in the u-th outer iteration and a 0-th inner iteration.
Step 1608: The controller determines whether f inner iterations are completed. If yes, perform Step 1610, otherwise, perform Step 1604.
Step 1610: The controller initializes Sc to 0.
Step 1612: The processing element computes Sᵥ and Sc according to PWᵥ×q_{if+u}+Sᵥ+Sc in the u-th outer iteration and a v-th inner iteration.
Step 1614: The controller determines whether f inner iterations are completed. If yes, perform Step 1616, otherwise, perform Step 1612.
Step 1616: The controller determines whether f outer iterations are completed. If yes, perform Step 1618, otherwise, perform Step 1602.
Step 1618: End.

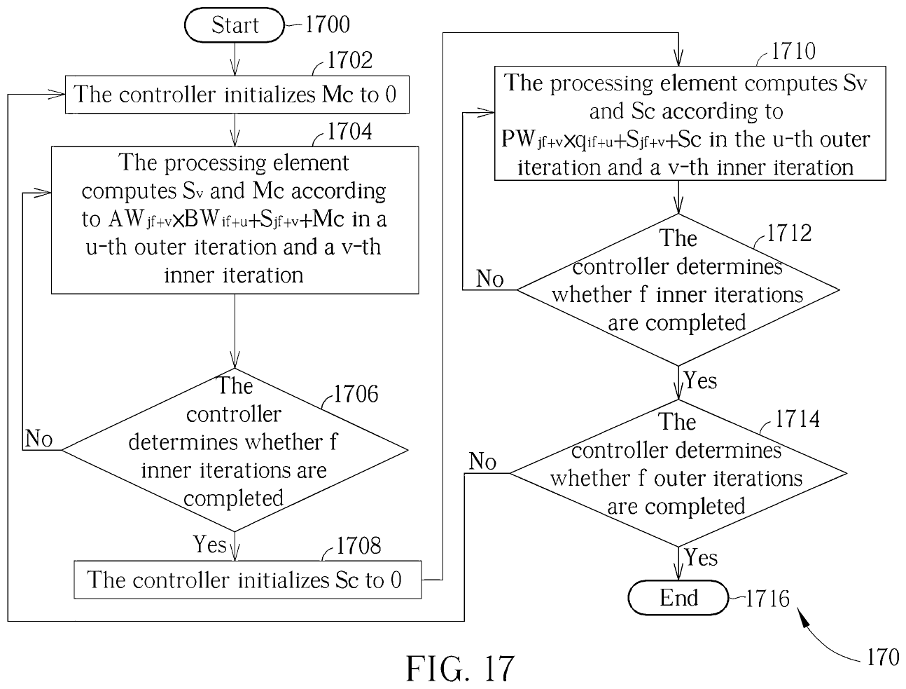

The block_1 process of Step 1514 in FIG. 15 may be realized by a process 170 shown in FIG. 17. The process 170 includes the following steps:
Step 1700: Start.
Step 1702: The controller initializes Mc to 0.
Step 1704: The processing element computes Sᵥ and Mc according to AW_{jf+v}×BW_{if+u}+S_{jf+v}+Mc in a u-th outer iteration and a v-th inner iteration.
Step 1706: The controller determines whether f inner iterations are completed. If yes, perform Step 1708, otherwise, perform Step 1704.
Step 1708: The controller initializes Sc to 0.
Step 1710: The processing element computes Sᵥ and Sc

according to PW_{jf+v}×q_{if+u}+S_{jf+v}+Sc in the u-th outer iteration and a v-th inner iteration.
Step 1712: The controller determines whether f inner iterations are completed. If yes, perform Step 1714, otherwise, perform Step 1710.
Step 1714: The controller determines whether f outer iterations are completed. If yes, perform Step 1716, otherwise, perform Step 1702.
Step 1716: End.

Detailed operations and variations of the processes 1500, 1600 and 1700 can be referred to the above illustration, and are not narrated herein.

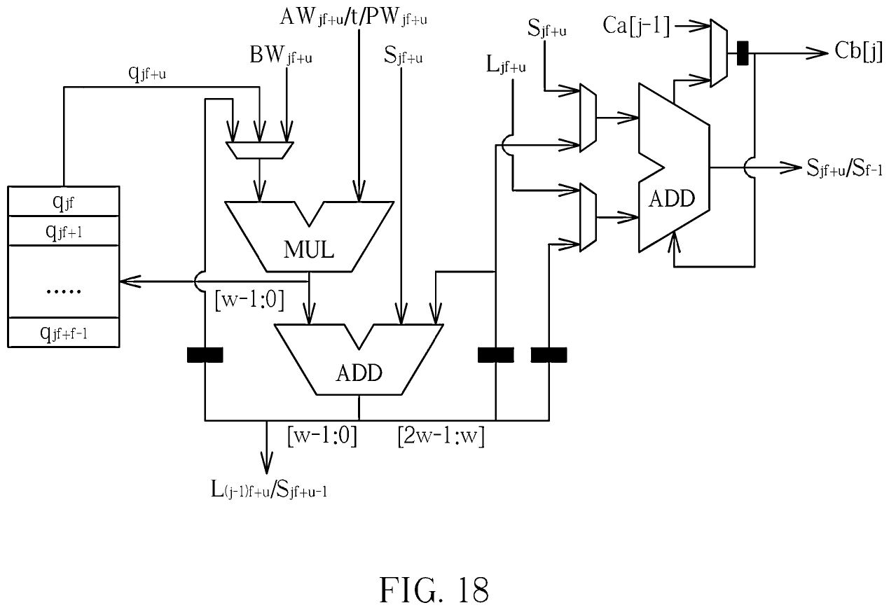

According to the above description, data flows of a processing element are shown in FIG. 18. In FIG. 18, t=−PW₀⁻¹ mod 2^{w}.

Note that the modular multiplication provided in the present invention may be regarded as an improved and efficient Montgomery modulation multiplication.

The operation of “determine” described above may be replaced by the operation of “compute”, “calculate”, “obtain”, “generate”, “output, “use”, “choose/select” or “decide”. The term of “according to” described above may be replaced by “in response to”. The phrase of “associated with” described above may be replaced by “of” or “corresponding to”. The term of “into” described above may be replaced by “to” or “in”. The term of “via” described above may be replaced by “on”, “in” or “at”. The term “at least one of . . . or . . . ” described above may be replaced by “at least one of . . . or at least one of . . . ” or “at least one selected from the group of . . . and . . . ”.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the modular operation device 10.

Examples of the hardware may include analog circuit(s), digital circuit(s) and/or mixed circuit(s). For example, the hardware may include ASIC(s), field programmable gate array(s) (FPGA(s)), programmable logic device(s), coupled hardware components or combination thereof. In another example, the hardware may include general-purpose processor(s), microprocessor(s), controller(s), digital signal processor(s) (DSP(s)) or combination thereof.

Examples of the software may include set(s) of codes, set(s) of instructions and/or set(s) of functions retained (e.g., stored) in a storage unit, e.g., a computer-readable medium. The computer-readable medium may include SIM, ROM, flash memory, RAM, CD-ROM/DVD-ROM/BD-ROM, magnetic tape, hard disk, optical data storage device, non-volatile storage unit, or combination thereof. The computer-readable medium (e.g., storage device) may be coupled to at least one processor internally (e.g., integrated) or externally (e.g., separated). The at least one processor which may include one or more modules may (e.g., be configured to) execute the software in the computer-readable medium. The set(s) of codes, the set(s) of instructions and/or the set(s) of functions may cause the at least one processor, the module(s), the hardware and/or the electronic system to perform the related steps.

Examples of the electronic system may include a system on chip (SoC), system in package (SiP), a computer on module (COM), a computer program product, an apparatus, a mobile phone, a laptop, a tablet computer, an electronic book or a portable computer system, and the modular operation device 10.

To sum up, the present invention provides a device and method of handling a modular multiplication. Operations performed by the modular operation device are defined. A two-step method is used for computing carry results and sum results. As a result, the problem regarding computing of iterative carry results and sum results is solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A modular operation device for handling modular multiplication, comprising:
a controller, configured to divide a multiplicand into a plurality of multiplicand blocks, a multiplier into a plurality of multiplier blocks, and a modulus into a plurality of modulus blocks;
a processing element, coupled to the controller, configured to execute instructions of:
computing a first plurality of sum results according to a first multiplicand block of the plurality of multiplicand blocks, a first multiplier block of the plurality of multiplier blocks and a first modulus block of the plurality of modulus blocks;
computing a second plurality of sum results and a plurality of delayed sum results according to a second multiplicand block of the plurality of multiplicand blocks, the first multiplier block and a second modulus block of the plurality of modulus blocks;
computing a first plurality of updated sum results according to the first plurality of sum results, the plurality of delayed sum results, the first multiplicand block, a second multiplier block of the plurality of multiplier blocks and the first modulus block;
computing a second plurality of updated sum results and a plurality of updated delayed sum results according to the second plurality of sum results, the second multiplicand block, the second multiplier block and the second modulus block; and
a reduction element, coupled to the controller and the processing element, configured to compute a resulting remainder according to the first plurality of updated sum results, the second plurality of updated sum results and the plurality of updated delayed sum results.

2. The modular operation device of claim 1, wherein a number of the plurality of delayed sum results and a number of the first plurality of sum results are the same.

3. The modular operation device of claim 1, further comprising:
at least one storage device;
a plurality of cache memories; and
a loading and storing element, coupled to the controller, configured to execute instructions of:
loading the first multiplicand block and the first modulus block from the at least one storage device to the plurality of cache memories, before the processing element computes the first plurality of sum results;
loading the second multiplicand block and the second modulus block from the at least one storage device to the plurality of cache memories, before the processing element computes the second plurality of sum results and the plurality of delayed sum results;
loading the first plurality of sum results, the plurality of delayed sum results, the first multiplicand block and the first modulus block from the at least one storage device to the plurality of cache memories, before the processing element computes the first plurality of updated sum results; and
loading the second plurality of sum results, the second multiplicand block and the second modulus block from the at least one storage device to the plurality of cache memories, before the processing element computes the second plurality of updated sum results and the plurality of updated delayed sum results.

4. The modular operation device of claim 3, wherein the loading and storing element is further configured to execute instructions of:
loading the first multiplicand block and the first modulus block to a first cache memory of the plurality of cache memories;
loading the second multiplicand block and the second modulus block to a second cache memory of the plurality of cache memories, when the processing element computes the first plurality of sum results;
loading the first plurality of sum results, the plurality of delayed sum results, the first multiplicand block and the first modulus block to the first cache memory, when the processing element computes the second plurality of sum results and the plurality of delayed sum results; and
loading the second plurality of sum results, the second multiplicand block and the second modulus block to the second cache memory, when the processing element computes the first plurality of updated sum results.

5. The modular operation device of claim 1, wherein the processing element is further configured to execute instructions of:
computing a first plurality of delayed carry results according to a most significant word of the first multiplicand block and the first multiplier block; and
computing a second plurality of delayed carry results according to the most significant word and the second multiplier block.

6. The modular operation device of claim 5, wherein the reduction element is further configured to execute instructions of:
computing the resulting remainder according to the first plurality of updated sum results, the second plurality of updated sum results, the plurality of updated delayed sum results, the first plurality of delayed carry results and the second plurality of delayed carry results.

7. The modular operation device of claim 1, wherein the processing element computes the plurality of delayed sum results according to a least significant word of the second multiplicand block and the first multiplier block, and compute the plurality of updated delayed sum results according to the least significant word and the first multiplier block.

8. The modular operation device of claim 1, wherein the processing element is further configured to execute instructions of:
computing a first delayed carry result according to a most significant word of the first multiplicand block and a most significant word of the first multiplier block;
determining the first delayed carry result as a most significant result of the first plurality of sum results;
computing a second delayed carry result according to a most significant word of the second multiplicand block and the most significant word of the first multiplier block; and
determining the second delayed carry result as a most significant result of the second plurality of sum results.

9. The modular operation device of claim 1, wherein the instruction of computing the first plurality of updated sum results comprises:
computing a plurality of temporary sum results according to the first plurality of sum results, the plurality of delayed sum results, the first multiplicand block and a first word of the second multiplicand block; and
computing the first plurality of updated sum results according to the plurality of temporary sum results, the first multiplicand block and a second word of the second multiplier block.

10. The modular operation device of claim 9, wherein the first word of the second multiplier block is a least significant word of the second multiplier block.

11. The modular operation device of claim 1, wherein the processing element is further configured to execute an instruction of:
computing an extra quotient according to a least significant result of the first plurality of sum results, a least significant result of the plurality of delayed sum results and an inverse word in an iteration corresponding to a least significant word of the second multiplier block, wherein the inverse word is a remainder of an inverse of a least significant word of the plurality of modulus blocks divided by a radix.
